(19) United States
(12) Patent Application Publication
(10) Pub. No.: US 2022/0417709 A1
(43) Pub. Date: Dec. 29, 2022

(54) METHOD AND APPARATUS FOR CONTROLLING MBS IN WIRELESS COMMUNICATION SYSTEM

(71) Applicant: Samsung Electronics Co., Ltd., Suwon-si (KR)

(72) Inventors: Youngkyo BAEK, Suwon-si (KR); Jicheol LEE, Suwon-si (KR)

(21) Appl. No.: 17/808,950

(22) Filed: Jun. 24, 2022

(30) Foreign Application Priority Data
Jun. 25, 2021 (KR) 10-2021-0083366

(51) Int. Cl. H04W 4/06; H04W 64/00

(52) U.S. Cl. CPC H04W 4/06; H04W 64/003; H04L 12/189

(57) ABSTRACT

The disclosure relates to a 5G or 6G communication system for supporting a higher data transmission rate. According to an embodiment of the disclosure, a method of controlling multicast and broadcast service (MBS) by a session management function (SMF) in a wireless communication system includes transmitting a first message including information about an MBS area and an MBS session identifier (ID) to an access and mobility management function (AMF), receiving a second message indicating that a user equipment receiving a service within the MBS area is located outside the MBS area from the AMF, determining that the UE is located outside the MBS area based on the second message, and processing a quality of service (QoS) flow applied to MBS traffic delivered by individual delivery.

### CROSS-REFERENCE TO RELATED APPLICATION

This application claims the benefit under 35 U.S.C. § 119(a) of a Korean patent application filed in the Korean Intellectual Property Office on Jun. 25, 2021, and assigned Serial No. 10-2021-0083366, the entire disclosure of which is incorporated herein by reference.

### BACKGROUND

### 1. Field

The disclosure relates to a method of providing multicast and broadcast service (MBS) to a user equipment (UE) in a wireless communication system, and more particularly, to a method of considering the mobility of a UE, when a 5^{th} generation (5G) network provides MBS to the UE.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

When multicast and broadcast service (MBS) is provided to a user equipment (UE) in a 5G network, a need for considering the mobility of the UE is emerging.

### SUMMARY

To provide multicast and broadcast service (MBS), a 5G system (5GS) may receive MBS data from an application function (AF) or a content provider and transmit the received MBS data to a next generation radio access network (NG-RAN). The NR-RAN may transmit the MBS data, for example, to user equipments (UEs) subscribed to the MBS.

For a UE receiving the MBS from an NG-RAN within an MBS service area, when the NR-RAN does not have an MBS capability, the NR-RAN transmits MBS data to the UE in an individual delivery method. When the UE moves out of the MBS service area, there is a need for a method of discontinuing the MBS data delivery to the UE.

According to an embodiment of the disclosure, a method of controlling multicast and broadcast service (MBS) by a session management function (SMF) in a wireless communication system may include transmitting a first message including information about an MBS area and an MBS session identifier (ID) to an access and mobility management function (AMF), receiving a second message indicating that a user equipment receiving a service within the MBS area is located outside the MBS area from the AMF, determining that the UE is located outside the MBS area based on the second message, and processing a quality of service (QoS) flow applied to MBS traffic delivered by individual delivery.

According to an embodiment, processing the QoS flow applied to the MBS traffic may include deleting the QoS flow, or dropping data traffic applied to a packet detection rule for the QoS flow.

According to an embodiment, the method may further include receiving a third message including a session join request of the UE and the MBS session ID from the AMF, and the first message may be transmitted to the AMF in response to the third message.

According to an embodiment, the first message may be a subscribe message for receiving an event notification when the UE located within the MBS area moves out of the MBS area.

According to an embodiment, the method may further include storing mapping information between the MBS session ID and a notification correlation ID, and identifying that the second message is an event notification for the MBS session ID based on the mapping information.

According to an embodiment, the UE may move from within the MBS area to an outside of the MBS area through Xn handover or N2 handover.

According to an embodiment, when the UE is placed in an idle state after the transmission of the first message and transmits a service request later, the SMF may receive the second message from the AMF.

According to an embodiment of the disclosure, a method of controlling MBS by an AMF in a wireless communication system may include receiving a first message including information about an MBS area and an MBS session ID from an SMF, and transmitting a second message indicating that a user equipment receiving a service within the MBS area is located outside the MBS area to the SMF. A QoS flow applied to MBS traffic delivered by individual delivery may be processed based on the second message.

According to an embodiment, the method may further include transmitting a third message including a session join request of the UE and the MBS session ID to the SMF, and the first message may be received from the SMF in response to the third message.

According to an embodiment of the disclosure, an SMF device for controlling MBS in a wireless communication system may include a transceiver, and a controller configured to transmit a first message including information about an MBS area and an MBS session ID to an AMF, receive a second message indicating that a user equipment receiving a service within the MBS area is located outside the MBS area from the AMF, determine that the UE is located outside the MBS area based on the second message, and process a QoS flow applied to MBS traffic delivered by individual delivery.

According to an embodiment of the disclosure, an AMF device for controlling MBS in a wireless communication system may include a transceiver, and a controller configured to receive a first message including information about an MBS area and an MBS ID from an SMF, and transmit a second message indicating that a user equipment receiving a service within the MBS area is located outside the MBS area to the SMF. A QoS flow applied to MBS traffic delivered by individual delivery may be processed based on the second message.

According to the disclosure, when a UE using MBS in a 5^{th} generation system (5GS) moves out of an MBS service area, the UE may be effectively restricted from using the MBS.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the disclosure will be more apparent from the following description taken in conjunction with the accompanying drawings, in which:

FIG. 1 illustrates a diagram of a situation in which when a user equipment (UE) moves out of a multicast and broadcast service (MBS) service area, MBS traffic control is required in a wireless communication system according to an embodiment of the disclosure;

FIGS. 2A and 2B illustrate diagrams of a process of restricting MBS traffic transmission, when a UE moves out of an MBS service area in a wireless communication system according to an embodiment of the disclosure;

FIGS. 3A and 3B illustrate diagrams of a process of restricting MBS traffic transmission, when a UE moves out of an MBS service area through handover according to an embodiment of the disclosure;

FIGS. 4A and 4B illustrate diagrams of a process of restricting MBS traffic transmission, when a UE moves out of an MBS service area through handover according to another embodiment of the disclosure;

FIGS. 5A and 5B illustrate diagrams of a process of restricting MBS traffic transmission, when a UE moves out of an MBS service area through handover according to another embodiment of the disclosure;

FIGS. 6A and 6B illustrate diagrams of a process of restricting MBS traffic transmission, when a UE moves out of an MBS service area through handover according to another embodiment of the disclosure;

FIGS. 7A and 7B illustrate diagrams of a process of restricting MBS traffic transmission, when a UE moves out of an MBS service area in an idle state according to an embodiment of the disclosure;

FIGS. 8A and 8B illustrate diagrams of a process of restricting MBS traffic transmission, when a UE moves out of an MBS service area in an idle state according to another embodiment of the disclosure;

FIG. 9 illustrates a diagram of the structure of a network entity according to an embodiment of the disclosure; and

FIG. 10 illustrates a diagram of the structure of a UE according to an embodiment of the disclosure.

Throughout the drawings, like reference numerals will be understood to refer to like parts, components, and structures.

### DETAILED DESCRIPTION

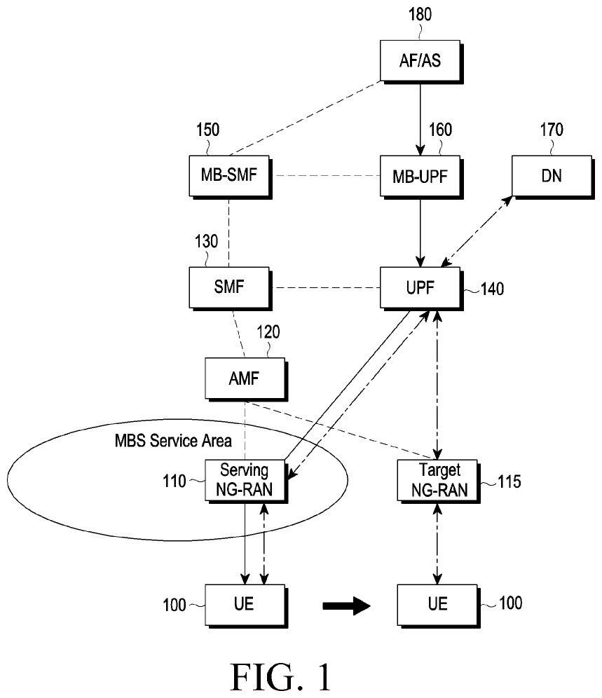

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The operation principle of the disclosure will be described below in detail with reference to the accompanying drawings. A detailed description of a generally known function or structure of the disclosure will be avoided lest it should obscure the subject matter of the disclosure. Although the terms as described later are defined in consideration of functions in the disclosure, the terms may be changed according to the intention of a user or an operator, or customs. Therefore, the definitions should be made, not simply by the actual terms used but by the meanings of each term lying within.

In the following description, a term identifying an access node, terms indicating network entities, terms indicating messages, a term indicating an interface between network objects, terms indicating various types of identification information, and so on are provided by way of example, for convenience of description. Accordingly, the disclosure is not limited to the terms described below, and other terms indicating objects having equivalent technical meanings may be used.

For convenience of description below, terms and names defined in the standards for a 5^{th} generation system (5GS) are used in the disclosure. However, the disclosure is not limited by the above terms and names, and may be equally applied to systems conforming to other standards.

There are two methods of delivering multicast and broadcast service (MBS) data to a next generation radio access network (NG-RAN) in a 5G core network: shared delivery and individual delivery. When the NG-RAN has an MBS capability, the MBS data may be transmitted from a multicast and broadcast user plane function (MB-UPF) device to the NG-RAN through a tunnel for shared delivery.

On the contrary, when the NG-RAN does not have the MBS capability, shared delivery is impossible. Therefore, MBS data received through the MB-UPF may be transmitted to a UE in an associated PDU session through a tunnel from a corresponding UPF to the NG-RAN by individual delivery.

Accordingly, for a UE receiving the MBS from an NG-RAN within an MBS service area, when the NG-RAN has no MBS capability, the NG-RAN transmits MBS data to the UE by individual delivery. When the UE moves out of the MBS service area, a method for discontinuing the MBS data delivery to the UE is required.

FIG. 1 illustrates a diagram of a situation in which MBS traffic control is required when a UE moves out of an MBS service area in a wireless communication system according to an embodiment of the disclosure.

When a UE which has received multicast traffic within a service area in the individual delivery method moves out of the service area, the UE may not receive the multicast traffic.

Referring to FIG. 1, a wireless communication (or cellular) system may include a UE 100, NG-RANs 110 and 115 as base stations (BSs), an access and mobility management function (AMF) device 120, a protocol data unit (PDU) session management function (SMF) device 130, a user plane function (UPF) device 140 of a PDU session, an multicast and broadcast-session management function (MB-SMF) device 150, a multicast and broadcast-user plane function (MB-UPF) device 160, a data network (DN) 170, and an application function (AF)/application server (AS) 180.

In describing FIG. 1, each network function (NF) of a 5G system (5GS) will be described as a “network function device” or “network function”. However, those skilled in the art will understand that an NF and/or an NF device may be implemented in one or more specific servers, and that two or more NFs performing the same operation may be implemented in one server.

One NF or two or more NFs may be implemented in the form of one network slice in some cases. A network slice may be created based on a specific purpose. For example, a network slice may be configured to provide the same type of service to specific subscriber groups. For example, a network slice may be configured for a subscriber group to provide at least one of a maximum data rate, a data usage, or a guaranteed minimum data rate. In addition, a network slice may be implemented according to various purposes.

In FIG. 1, an interface for a control message between nodes is marked with a thin dotted line, and a path through which data traffic is transmitted is marked with a thick line. For example, multicast data traffic may be delivered from the AF/AS 180 to the MB-UPF 160. On the assumption that a serving NG-RAN (S-NG-RAN) 110 of the UE 100 does not have an MBS capability, the multicast data traffic may be transmitted to the S-NG-RAN 110 through the UPF 140, and then to the UE 100 in the individual delivery method. General data traffic may be provided to the UE 100 through the DN 170, the UPF 140, and the S-NG-RAN 110 through an associated PDU session used for the individual delivery method. However, when the UE 100 moves out of an MBS service area (i.e., when the UE 100 is serviced by a target NG-RAN (T-NG-RAN) 115 outside the MBS service area), multicast data traffic should be controlled not to be transmitted to the T-NG-RAN 115, although the general data traffic is still serviced to the UE 100.

In general, to support the MBS in the 5GS, a cellular system for the MBS may be configured with the following NF devices and services.

The AF/AS 180 may be implemented, for example, as at least one of a vehicle to everything (V2X) application server, a consumer Internet of things (CIoT) application server, a mission critical push to talk (MCPTT) application, a content provider, a TV or audio service provider, or a streaming video service provider.

When requesting a multicast service from the MB-SMF 150, the AF/AS 180 may request multicast service area (or MBS service area) information. The MB-SMF 150 may manage a multicast session, allocate a temporary mobile group identity (TMGI) to the multicast session, and control the MB-UPF 160. The MB-UPF 160 may serve as a user plane function that receives data traffic for a multicast session and transmits the data traffic.

When the UE 100 wants to join the multicast session, the UE 100 may request to join the multicast session by a PDU session modification request message. Upon receipt of the multicast session join request, the SMF 130 may obtain context information about the multicast session from the MB-SMF 150 and manage mapping between the multicast session and a PDU session. The PDU session may be referred to as an associated PDU session.

The SMF 130 may store mapping information between a multicast session ID and a PDU session ID from a multicast session context, and mapping information between multicast quality of service (QoS) flow information in the case of the shared delivery method and unicast QoS flow information in the case of the individual delivery method, for delivery of multicast session traffic. The SMF 130 may apply QoS according to a used transmission method (the shared delivery method or the individual delivery method). A unicast QoS flow applied to the PDU session may be referred to as an associated QoS flow.

The SMF 130 may store a downlink (DL) packet detection rule (PDR) including a service data flow (SDF) template for mapping an SDF of a multicast session to an associated QoS flow. The SMF 130 may transmit the DL PDR to the UPF 140, and when the individual delivery method is used, control to apply multicast service traffic through the associated QOS flow of the associated PDU session according to the associated QoS flow information, that is, a QoS profile.

In this specification, multicast session and MBS session are used interchangeably in the same meaning, and multicast session ID and MBS session ID are used interchangeably in the same meaning for specifying a multicast session. In addition, multicast service area and MBS service area are used interchangeably in the same meaning of an area allowing reception of a multicast service.

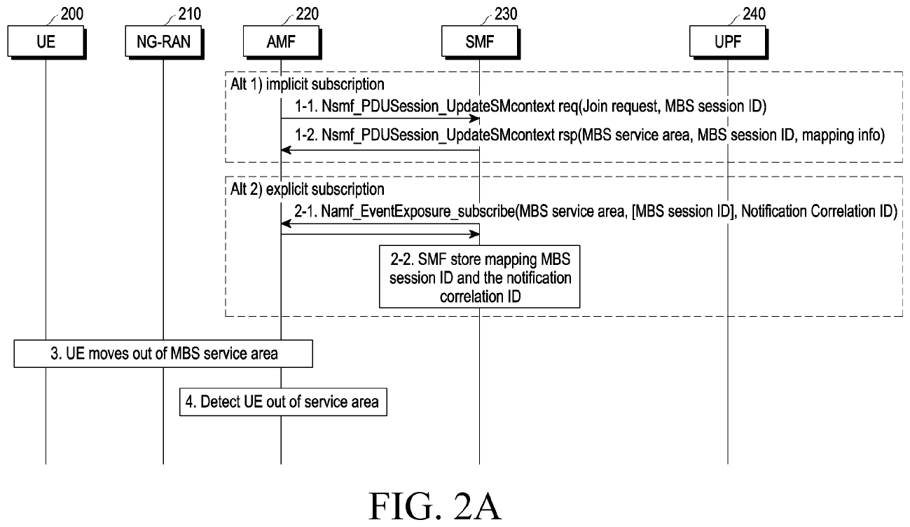

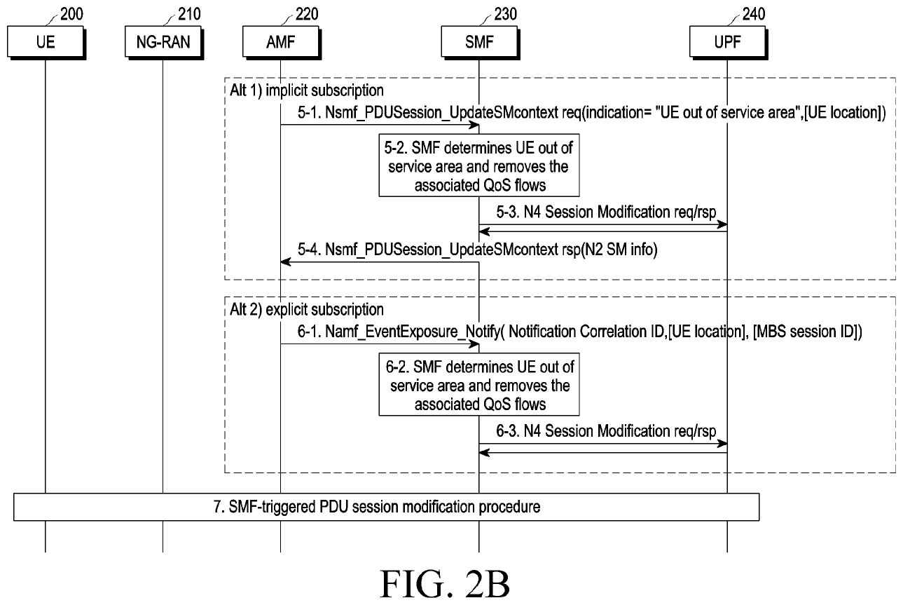

FIGS. 2A and 2B illustrate diagrams of a process of restricting MBS traffic transmission when a UE moves out of an MBS service area in a wireless communication system according to an embodiment of the disclosure.

According to an embodiment of the disclosure, when a network recognizes that a UE receiving multicast traffic (or MBS traffic) in the individual delivery method has moved out of a service area, the network may restrict the multicast traffic transmission.

Referring to FIGS. 2A and 2B, a multicast traffic control process may be performed through an associated PDU session used for the individual delivery method. According to an embodiment, when a UE 200 requests to join a multicast session, an SMF 230 may directly or indirectly perform event subscription in a PDU session modification procedure to request a notification from an AMF 220 and thus obtain location information about the UE 200, when the UE 200 moves out of an MBS service area.

According to an embodiment, when the UE 200 requests to join the multicast session, the SMF 230 may recognize that the UE 200 is located outside the service area by an implicit subscription method, and delete an associated QoS flow (Alt 1).

According to another embodiment, the SMF 230 may recognize that the UE 200 is located outside the service area by an explicit subscription method, and delete the associated QoS flow (Alt 2).

Referring to FIG. 2A, according to an embodiment, the AMF 220 may transmit an Nsmf_PDUSession_UpdateSMcontext request message (including a join request and an MBS session ID) to the SMF 230 in step 1-1. Upon receipt of the join request, the SMF 230 may store (or generate), as an MBS session context for the MBS session ID, at least one of MBS service area information, mapping information between the MBS session ID and an associated PDU session ID, mapping information between multicast QoS flow information and associated QoS flow information, or updated QoS flow information for a PDU session, based on an MBS session context received from an MB-SMF. The MBS service area information may be a TAI list, a cell ID list, or an NG-RAN node ID list, the QoS flow information may include a QoS flow identifier (QFI) and a QoS profile, and the QoS profile may include information indicating a guaranteed bit rate (GBR) or a non-GBR, a 5G QoS Identifier (5QI), an allocation and retention priority (ARP), a guaranteed flow bit rate (GFBR), and a maximum flow bit rate (MFBR). The SMF 230 may store a DL PDR including an SDF template for mapping SDFs of the multicast session to the associated QoS flow.

An SDF template mapped to the associated QoS flow may include multicast IP address information and port information, or unicast IP address information and port information, or lower layer multicast address (LL MC address) information, for providing multicast data from an MB-UPF, which is a user plane anchor for the MBS session, to a UPF 240. When individual delivery is applied, the SMF 230 may transmit, to a UE 200, the MBS session ID, and the multicast IP address information and port information, the unicast IP address information and port information, or the LL MC address information, for the MBS session ID, which is information for receiving multicast traffic from the MB-UPF for the multicast session, along with the information about the SDF template mapped to the associated QoS flow in an N4 session establishment or N4 session modification process.

The UPF 240 may receive multicast traffic corresponding to the multicast session from the MB-UPF according to the information received from the SMF 230, and deliver the multicast traffic to the UE 200 through the associated PDU session. The UPF 240 may receive one copy of the multicast traffic provided by the MB-UPF, for each MBS session, copy the multicast traffic to the associated PDU session of each UE joining the MBS session, and forward the copy, without the need for receiving the multicast traffic for each UE from the MB-UPF.

In step 1-2, the SMF 230 may respond to the NG-RAN 210 with an Nsmf_PDUSession_UpdateSMcontext response message including at least one of the MBS service area information, the MBS session ID, or the mapping information between the MBS session ID and the PDU session ID to the AMF 220. The SMF 230 may transmit the MBS service area information, the MBS session ID, the mapping information between the MBS session ID and the PDU session ID, the mapping information between the multicast QoS flow information and the associated QoS flow information, and the updated QoS flow information for the PDU session in an N2 SM container. Upon receipt of the Nsmf_PDUSession_UpdateSMcontext response message, the AMF 220 may notify the SMF 230 of the UE's movement out of the indicated MBS service area, when the UE 200 moves out of the MBS service area, as in step 5-1.

According to another embodiment, in step 2-1, the SMF 230 may directly transmit a Namf_EventExposure_subscribe message (including at least one of MBS service area information, the MBS session ID, or a notification correlation ID) to the AMF 220 to subscribe to event notification, so that when the UE 200 moves out of the MBS service area, a notification may be received. As in step 2-2, the SMF 230 subscribed to the event notification may store mapping information between the MBS session ID and the notification correlation ID to determine an MBS session for which a notification is. When the UE 200 moves out of the MBS service area, the AMF 220 may notify the SMF 230 of the UE's movement as in step 6-1.

When the UE 200 moves out of the MBS service area as in step 3, the AMF 220 may recognize that the UE 200 has moved out of the MBS service area from information transmitted by the NG-RAN 210 in step 4.

According to an embodiment, when a notification of a situation in which the UE 200 moves out of the MBS service area is requested indirectly as in steps 1-1 and 1-2, the AMF 220 may notify the SMF 230 controlling the associated PDU session mapped to the MBS session that “the UE 200 has moved out of the MBS service area corresponding to the MBS session ID” by an Nsmf_PDUSession_UpdateSMcontext req message (indication=“UE out of service area”, [UE location] included).

The Nsmf_PDUSession_UpdateSMcontext req message may include an indication indicating that the UE 200 has moved out of the service area or location information about the UE 200 (e.g., a TAI, a cell ID, or an NG-RAN node ID of an NG-RAN to which the UE has moved), and may additionally include the MBS session ID.

Upon receipt of the Nsmf_PDUSession_UpdateSMcontext req message, the SMF 230 may recognize that the UE 200 has moved out of the service area of the multicast session as in step 5-2. To control the UE 200 not to receive multicast service data through the associated PDU session mapped to the multicast session, the SMF 230 may delete the stored associated QoS flow of the associated PDU session mapped to the multicast QoS flow information of the multicast session, and the SDF template corresponding to the associated QoS flow in step 5-2.

Even though the SMF 230 does not delete the associated QoS flow and the SDF template corresponding to the associated QoS flow, the UPF 240 which has received the multicast data traffic from the MB-UPF may control not to forward multicast data traffic corresponding to the DL PDR including the SDF template for the associated QoS flow of the associated PDU session of the UE 200 to the associated PDU session of the UE 100 or to drop the multicast data traffic. For example, the SMF 230 may transmit/receive an N4 Session Modification request/response to/from the UPF 240 so that an SDF corresponding to multicast data traffic from the multicast session may not be forwarded to the associated PDU session of the UE 200 or the multicast data traffic may be dropped, and thus the UE 100 may not receive any more multicast data, as in step 5-3.

In step 5-4, the SMF 230 may transmit updated QoS flow information in an N2 SM container of a Nsmf_PDUSession_UpdateSMcontext response message to the AMF 220 and the NG-RAN 210. The SMF 230 may perform a PDU session modification procedure as in step 7 to synchronize the QoS flow information between the UE 200 and the network.

According to another embodiment, when the SMF 230 has directly requested an event notification for a situation in which the UE 200 moves out of the MBS service area from the AMF 220 as in steps 2-1 and 2-2, the AMF 220 may indicate that the UE 200 has moved out of the MBS service area as in the requested event to the SMF 230 which has subscribed to the event notification by a Namf_EventExposure_Notify message (including at least one of the notification correlation ID, a UE location, or the MBS session ID) as in step 6-1.

The Namf_EventExposure_Notify message may include event information indicating that the UE 200 has moved out of the service area, the notification correlation ID generated in step 2-1 during the subscription to the event notification, or location information about the UE 200 (e.g., a TAI, a cell ID or an NG-RAN node ID of an NG-RAN to which the UE has moved), may further include the MBS session ID, and may be delivered to the SMF 230.

Upon receipt of the Namf_EventExposure_Notify message, the SMF 230 may recognize that the UE 200 has moved out of the service area of the multicast session, for the MBS session corresponding to the notification correlation ID as in step 6-2. To control the UE 200 not to receive multicast service data through the associated PDU session mapped to the multicast session, the SMF 230 may delete the associated QoS flow of the associated PDU session mapped to the multicast QoS flow information of the multicast session, and the SDF template corresponding to the associated QoS flow, stored in the SMF 230 in step 6-2.

Even though the SMF 230 does not delete the associated QoS flow and the SDF template corresponding to the associated QoS flow, the UPF 240 which has received the multicast data traffic from the MB-UPF may control not to forward multicast data traffic corresponding to the DL PDR including the SDF template for the associated QoS flow of the associated PDU session to the associated PDU session of the UE 200 or to drop the multicast traffic. For example, as in step 6-3, the SMF 230 may transmit/receive an N4 Session Modification request/response to/from the UPF 240 so that an SDF corresponding to multicast data traffic from the multicast session may not be forwarded to the associated PDU session of the UE 200 or the multicast data traffic may be dropped, and thus the UE 100 may not receive any more multicast data.

As in step 7, the SMF 230 may perform the PDU session modification procedure to synchronize the updated QoS flow information between the UE 200 and the network. The QoS flow information may be synchronized among the UE 200, the NG-RAN 210, and the core network in step 7.

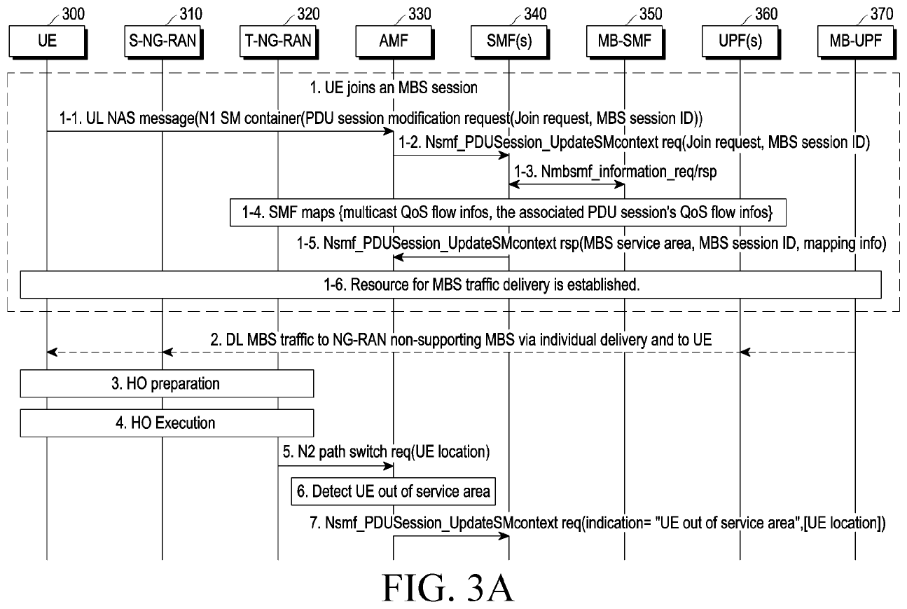

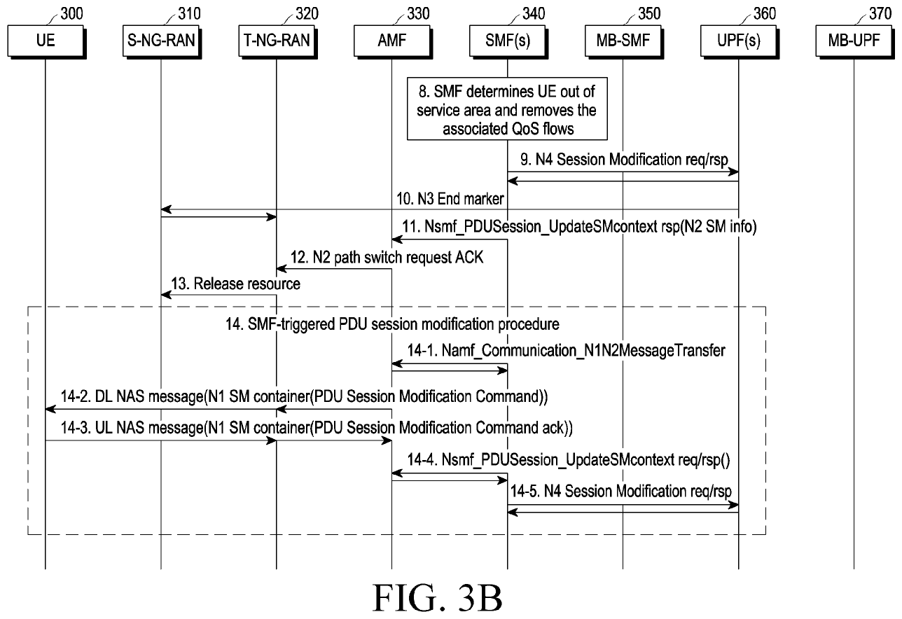

FIGS. 3A and 3B illustrate diagrams of a process of restricting MBS traffic transmission when a UE moves out of an MBS service area through handover according to an embodiment of the disclosure.

When a UE, which has received a multicast traffic service in the individual delivery method, moves out of a service area through Xn handover, a network may recognize the UE being out of the service area and restrict transmission of the multicast traffic to the UE.

Referring to FIG. 3A, an SMF 340 may indirectly perform event subscription to an AMF 330 to request a notification in the case of a UE 300 out of an MBS service area in the process of processing a join request for a multicast session from the UE 300 to receive a multicast session service.

In step 1-1, the UE 300 may request to join the multicast session by a PDU session modification request. When the AMF 330 transmits an Nsmf_PDUSession_UpdateSMcontext request message (including a join request and an MBS session ID) to the SMF 340 in step 1-2, in the absence of an MBS session context for the multicast session ID for which the request is made, the SMF 340 may obtain multicast QoS flow information for the multicast session from an MB-SMF 350 in step 1-3.

In step 1-3, the SMF 340 may obtain mapping information between multicast QoS flow information for the multicast session and QoS flow information for an associated PDU session, or may request the QoS flow information for the associated PDU session corresponding received multicast QoS flow information from a PCF and receive the received QoS flow information for the associated PDU session. The SMF 340 may obtain the mapping information by autonomously generating the QoS flow information for the associated PDU session based on the received multicast QoS flow information.

In step 1-4, the SMF 340 may store (or generate), as an MBS session context, at least one of MBS service area information for the MBS session ID, mapping information between the MBS session ID and an associated PDU session ID, mapping information between the multicast QoS flow information and the associated QoS flow information, or updated QoS flow information for a PDU session. The MBS service area information may be a TAI list, a cell ID list, or an NG-RAN node ID list, the QoS flow information may include a QFI and a QoS profile, and the QoS profile may include information indicating a GBR or a non-GBR, a 5QI, an ARP, a GFBR, and an MFBR.

The SMF 340 may store a DL PDR including an SDF template for mapping an SDF of the multicast session to an associated QoS flow. For example, the SDF template mapped to the associated QoS flow may include multicast IP address information and port information, or unicast IP address information and port information, or LL MC address information, for providing multicast data from an MB-UPF 370, which is a user plane anchor for the MBS session, to a UPF 360.

In step 1-5, the SMF 340 may transmit an Nsmf_PDUSession_UpdateSMcontext response message including at least one of the MBS service area information, the MBS session ID, or the mapping information between the MBS session ID and the PDU session ID to the AMF 330. The SMF 340 may respond to an NG-RAN with at least one of the MBS service area information, the MBS session ID, the mapping information between the MBS session ID and the PDU session ID, the mapping information between the multicast QoS flow information and the associated QoS flow information, or the updated QoS flow information for the PDU session in an N2 SM container. Upon receipt of the Nsmf_PDUSession_UpdateSMcontext response message, the AMF 330 may perform a multicast traffic transmission procedure with an NG-RAN node as in step 1-6.

Subsequently, when the UE 300 receives a service from an S-NG-RAN 310 that does not support an MBS function, multicast data may be transmitted to the UE 300 through the associated PDU session in the individual delivery method as in step 2. When the UE 300 performs Xn handover from the S-NG-RAN 310 to a T-NG-RAN 320 outside the multicast service area in steps 3 and 4, the T-NG-RAN 320 may request data path switch by transmitting an N2 path switch request (including a UE location) to a core network as in step 5. Upon receipt of the data path switch request, the AMF 330 may recognize that the UE 200 has moved out of the MBS service area as in step 6.

In step 7, the AMF 330 may transmit an Nsmf_PDUSession_UpdateSMcontext req message (indication=“UE out of service area”, [UE location] included) to the SMF 340 controlling the associated PDU session mapped to the MBS session. The Nsmf_PDUSession_UpdateSMcontext req message may include an indication indicating that the UE 300 has moved out of the service area or location information about the UE 300 (e.g., a TAI, a cell ID, or an NG-RAN node ID of an NG-RAN to which the UE has moved), and further include the MBS session ID.

Upon receipt of the Nsmf_PDUSession_UpdateSMcontext req message, the SMF 340 may recognize that the UE 300 has moved out of the service area of the multicast session as in step 8. To control the UE 300 not to receive multicast service data through the associated PDU session mapped to the multicast session, the SMF 340 may delete the stored associated QoS flow of the associated PDU session mapped to the multicast QoS flow information for the multicast session, and the SDF template corresponding to the associated QoS flow.

Even though the SMF 340 does not delete the associated QoS flow and the SDF template corresponding to the associated QoS flow, the UPF 360 which has received the multicast data traffic from the MB-UPF may control not to forward multicast data traffic corresponding to the DL PDR including the SDF template for the associated QoS flow of the associated PDU session of the UE 300 to the associated PDU session to the UE 100 or to drop the multicast data traffic. For example, the SMF 340 may transmit/receive an N4 Session Modification request/response to/from the UPF 360 so that the SDF corresponding to multicast data traffic from the multicast session may not be forwarded to the associated PDU session of the UE 300 or the multicast data traffic may be dropped, and thus the UE 300 may not receive any more multicast data, as in step 9.

In step 10, the UPF 360 may transmit an N3 End marker message to the S-NG-RAN 310, and the S-NG-RAN 310 may forward the message to the T-NG-RAN 320.

As in steps 11 and 12, the SMF 340 may transmit updated QoS flow information to the AMF 330 and the T-NG-RAN 320 in an N2 SM container of a Nsmf_PDUSession_UpdateSMcontext response message, so that the updated QoS flow information may be applied. Upon receipt of an N2 path switch request ACK in step 12, the T-NG-RAN 320 may complete the handover by allowing the S-NG-RAN 310 to release resources in step 13.

Since QoS flow information has been changed in the network, the SMF 340 may perform a PDU session modification procedure to synchronize the QoS flow information between the UE 300 and the network as in step 14.

In step 14-1, the SMF 340 may transmit and receive a Namf_Communication_N1M2Message Transfer message to and from the AMF 330. In step 14-2, the AMF 330 may transmit an N1 SM container including a PDU Session Modification Command to the T-NG-RAN 320 by a DL NAS message, and the T-NG-RAN 320 may transmit the DL NAS message to the UE 300. In step 14-3, the UE 300 may transmit an N1 SM container including a PDU Session Modification Command ack to the T-NG-RAN 320 by a UL NAS message, and the T-NG-RAN 320 may transmit a UL A NAS message to the AMF 330.

In step 14-4, the AMF 330 may transmit and receive an Nsmf_PDUSession_UpdateSMcontext request/response message to and from the SMF 340, and in step 14-5, the SMF 340 may transmit/receive an N4 Session Modification request/response message to and from the UPF 360.

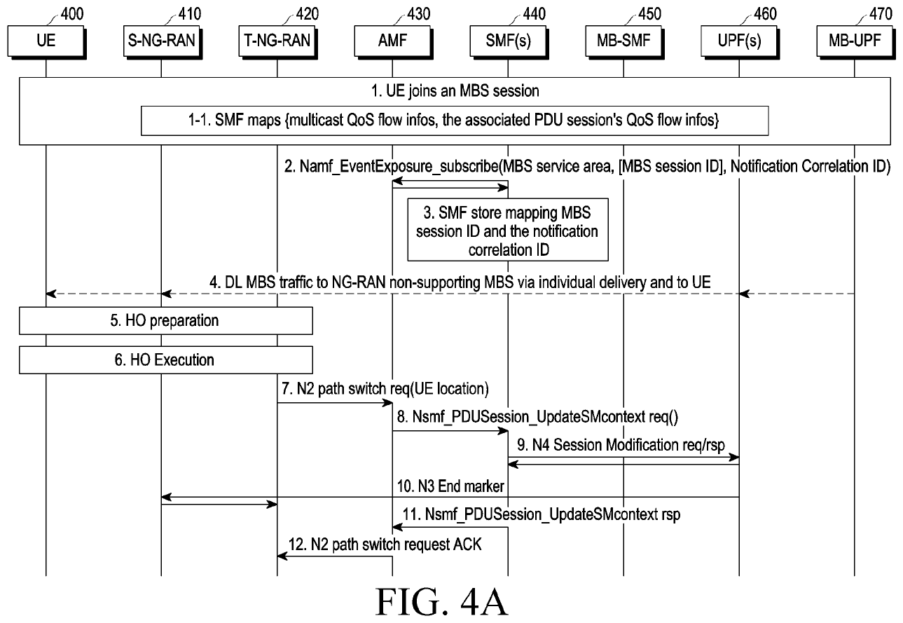

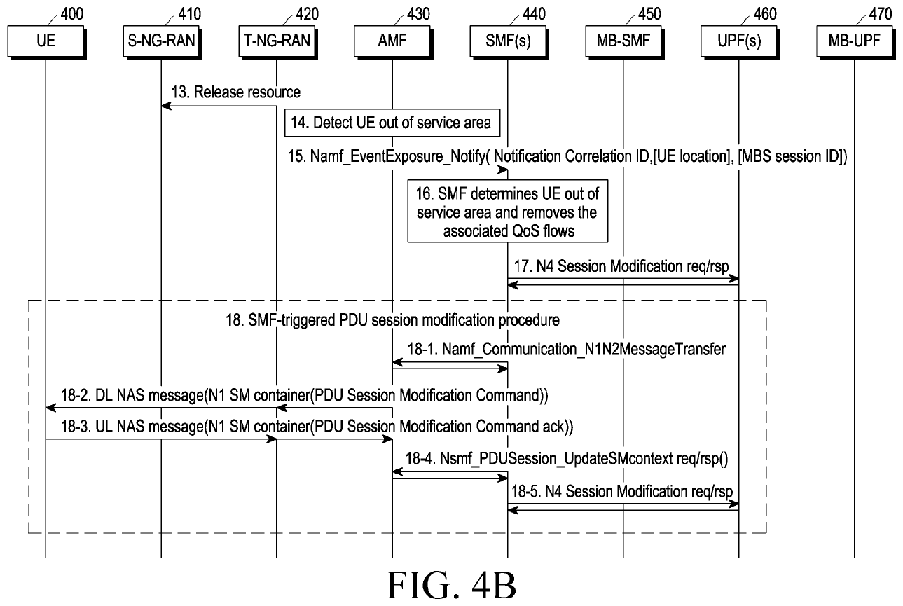

FIGS. 4A and 4B illustrate diagrams of a process of restricting MBS traffic transmission when a UE moves out of an MBS service area through handover according to another embodiment of the disclosure.

According to an embodiment of the disclosure, when a UE, which has received a multicast traffic service in the individual delivery method, moves out of a service area through Xn handover, a network may recognize the UE being out of the service area, and restrict transmission of multicast traffic to the UE.

Referring to FIG. 4A, an SMF 440 may directly perform event subscription to an AMF 430 to request a notification in the case of a UE 400 out of an MBS service area.

As in step 1, the UE 400 may request to join a multicast session by a PDU session modification request, to receive a multicast session service. When the AMF 430 transmits an Nsmf_PDUSession_UpdateSMcontext request message (including a join request and an MBS session ID) to the SMF 440 in the process of processing the join request for the multicast session, in the absence of an MBS session context for the multicast session ID for which the request is made, the SMF 440 receiving the join request may obtain multicast QoS flow information for the multicast session from an MB-SMF 450.

The SMF 440 may obtain mapping information between the multicast QoS flow information for the multicast session and QoS flow information for an associated PDU session. The SMF 440 may request the QoS flow information for the associated PDU session corresponding the multicast QoS flow information from a PCF and receive the QoS flow information for the associated PDU session corresponding to the multicast QoS flow information. The SMF 440 may obtain the mapping information by autonomously generating the QoS flow information for the associated PDU session based on the multicast QoS flow information.

In step 1-1, the SMF 440 may store (or generate), as an MBS session context for the MBS session ID, at least one of MBS service area information for the MBS session ID, mapping information between the MBS session ID and an associated PDU session ID, the mapping information between the multicast QoS flow information and the associated QoS flow information, or updated QoS flow information for a PDU session.

The MBS service area information may be a TAI list, a cell ID list, or an NG-RAN node ID list, the QoS flow information may include a QFI and a QoS profile, and the QoS profile may include information indicating a GBR or a non-GBR, a 5QI, an ARP, a GFBR, and an MFBR.

The SMF 440 may store a DL PDR including an SDF template for mapping an SDF of the multicast session to the associated QoS flow. For example, the SDF template mapped to the associated QoS flow may include at least one of multicast IP address information and port information, unicast IP address information and port information, or LL MC address information, for providing multicast data from an MB-UPF 470, which is a user plane anchor for the MBS session, to a UPF 460.

When the SMF 440 transmits a response to the AMF 430 by an Nsmf_PDUSession_UpdateSMcontext response message, the SMF 440 may transmit at least one of the MBS service area information, the MBS session ID, or the mapping information between the MBS session ID and the PDU session ID. The SMF 440 may respond to an NG-RAN with at least one of the MBS service area information, the MBS session ID, the mapping information between the MBS session ID and the PDU session ID, the mapping information between the multicast QoS flow information and the associated QoS flow information, or updated QoS flow information for the PDU session in an N2 SM container. Upon receipt of the Nsmf_PDUSession_UpdateSMcontext response message, the AMF 430 may perform a multicast traffic transmission procedure with an NG-RAN node.

When the UE 400 is located in a T-NG-RAN 420 that does not support an MBS function after joining, the SMF 440 transmits multicast data to the UE 400 in the individual delivery method. In step 2, the SMF 440 may subscribe to event notification, requesting a notification in the case of the UE 400 being out of the MBS service area by directly transmitting a Namf_EventExposure_subscribe message (including at least one of the MBS service area information, the MBS session ID, or a notification correlation ID) to the AMF 430.

As in step 3, the SMF 440 which has subscribed to the event notification may store the mapping information between the MBS session ID and the notification correlation ID, to identify an MBS session for which a received notification is. When the UE 400 moves out of the MBS service area, the AMF 430 may notify the SMF 440 of the UE 400 being out of the MBS service area.

As in step 4, when the UE 400 is located in the T-NG-RAN 420 that does not support the MBS function, multicast data may be transmitted to the UE 400 through the associated PDU session in the individual delivery method.

When the UE 300 performs Xn handover to the T-NG-RAN 420 outside the multicast service area in steps 5 and 6, the T-NG-RAN 420 may request data path switch by transmitting an N2 path switch request (including a UE location) to a core network as in step 7. Upon receipt of the data path switch request, the AMF 430 may recognize that the UE 400 has moved out of the MBS service area.

The AMF 430 may transmit a Nsmf_PDUSession_UpdateSMcontext req message to the SMF 440 controlling the associated PDU session in step 8, and notify the UPF 460 of an associated change to modify a data path tunnel for the associated PDU session as in step 9. In step 10, the UPF 460 may transmit an N3 End marker message to an S-NG-RAN 410, and the S-NG-RAN 410 may forward the message to the T-NG-RAN 420.

As in steps 11 and 12, the SMF 440 may transmit updated QoS flow information and tunnel endpoint information in an N2 SM container of a Nsmf_PDUSession_UpdateSMcontext response message to the AMF 430 and the T-NG-RAN 420 in a handover procedure. The T-NG-RAN 420 may receive an N2 path switch request ACK in step 12 and complete the handover by allowing the S-NG-RAN 410 to release resources in step 13.

The AMF 430, which has received the N2 path switch request message (including the UE location) from the T-NG-RAN 420 in step 7 according to the handover procedure may recognize that the UE 400 has moved out of the multicast service area as in step 14. Because the SMF 440 has subscribed to the event notification for the case of the UE 400 being out of the multicast service area, the AMF 430 may transmit a Namf_EventExposure_Notify message (including the notification correlation ID, the UE location, and the MBS session ID) indicating “the UE out of the MBS service area” to the SMF 440 subscribed to the event notification.

The Namf_EventExposure_Notify message may include event information indicating the UE 400 being out of the service area, the notification correlation ID generated in step 2 during the subscription to the event notification, or location information about the UE 400 (e.g., a TAI, a cell ID, or an NG-RAN node ID of an NG-RAN to which the UE has moved), further include MBS session ID information, and be transmitted to the SMF 440.

As in step 16, upon receipt of the Namf_EventExposure_Notify message, the SMF 440 may recognize that the UE 400 has moved out of the service area of the multicast session, for the MBS session corresponding to the notification correlation ID, and control the UE 400 not to receive multicast service data through the associated PDU session mapped to the multicast session. The SMF 440 may delete the associated QoS flow of the associated PDU session mapped to the stored multicast QoS flow information for the multicast session, and the SDF template corresponding to the associated QoS flow.

Even though the SMF 440 does not delete the associated QoS flow and the SDF template corresponding to the associated QoS flow, the UPF 460 which has received the multicast data traffic from the MB-UPF 470 may control not to forward multicast data traffic corresponding to the DL PDR including the SDF template for the associated QoS flow of the associated PDU session of the UE 400 or to drop the multicast data traffic. For example, the SMF 440 may transmit/receive an N4 Session Modification request/response to/from the UPF 460 so that the SDF corresponding to multicast data traffic from the multicast session may not be forwarded to the associated PDU session of the UE 400 or the multicast data traffic may be dropped, and thus the UE 300 may not receive any more multicast data, as in step 17.

As in step 18, the SMF 440 may perform a PDU session modification procedure to synchronize updated QoS flow information between the UE 400 and the network (steps 18-1 to 18-5), and the QoS flow information may be synchronized among the UE 400, the NG-RAN 420, and the core network.

According to an embodiment, steps 14 to 17 may be performed in parallel with or before the handover procedure, that is, steps 8 to 13. Accordingly, when messages generated in the two procedures overlap, the messages may be integrated into one message and transmitted.

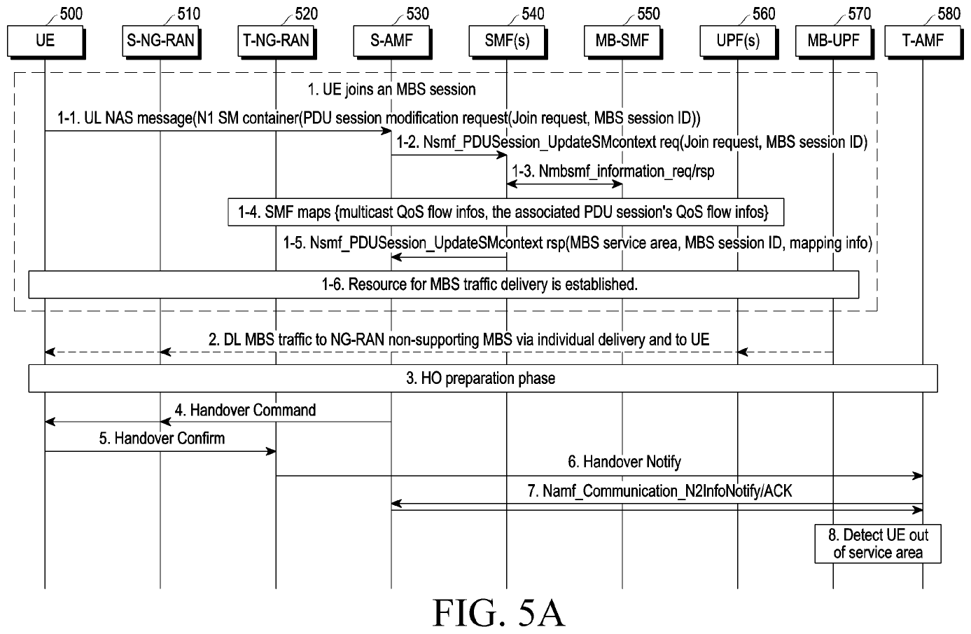

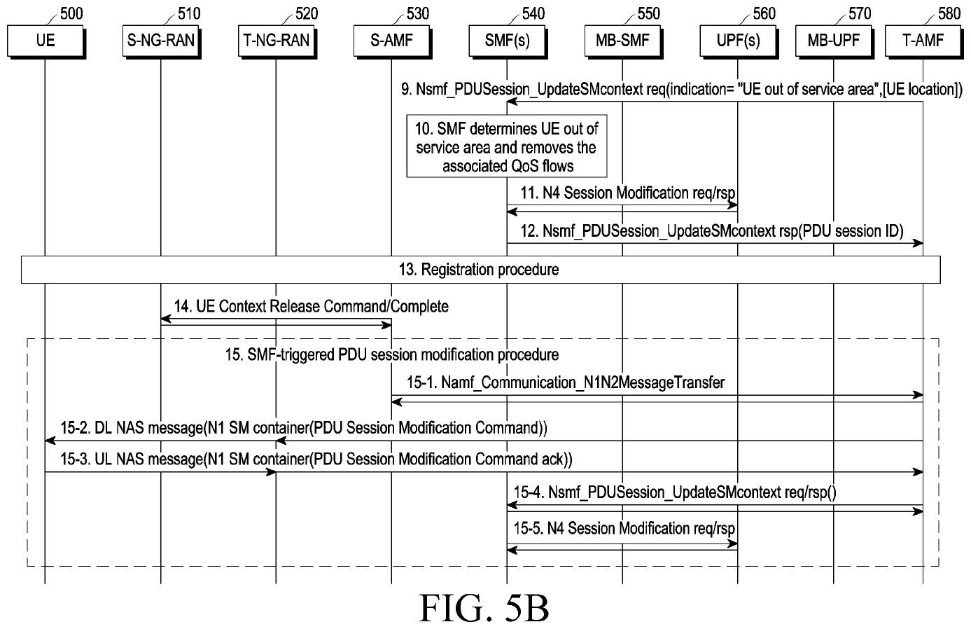

FIGS. 5A and 5B illustrate diagrams of a process of restricting MBS traffic transmission when a UE moves out of an MBS service area through handover according to another embodiment of the disclosure.

When a UE 500, which has received a multicast traffic service in the individual delivery method, moves out of a service area through N2 handover, a network may recognize the UE being out of the service area, and restrict transmission of the multicast traffic to the UE 500. An S-NG-RAN 510 that provides a service to the UE 500 may be switched to a T-NG-RAN 520, and a serving AMF (S-AMF) 530 may be switched to a target AMF (T-AMF) 580 through the N2 handover.

Referring to FIG. 5A, an SMF 540 may indirectly perform event subscription to the S-AMF 530 to request a notification in the case of the UE 500 out of an MBS service area in the process of processing a join request for a multicast session from the UE 500 to receive a multicast session service, as in step 1-1. In step 1-1, the UE 500 may request to join the multicast session by a PDU session modification request. When the S-AMF 530 transmits an Nsmf_PDUSession_UpdateSMcontext request message (including a join request and an MBS session ID) to the SMF 540 in step 1-2, in the absence of an MBS session context for the multicast session ID for which the request is made, the SMF 540 receiving the join request may obtain multicast QoS flow information for the multicast session from an MB-SMF 550 in step 1-3.

In step 1-3, the SMF 540 may obtain mapping information between the multicast QoS flow information for the multicast session and QoS flow information for an associated PDU session. The SMF 540 may request the QoS flow information for the associated PDU session corresponding to the multicast QoS flow information from a PCF and receive the QoS flow information for the associated PDU session. The SMF 540 may obtain the mapping information by autonomously generating the QoS flow information for the associated PDU session based on the multicast QoS flow information.

The SMF 540 may store (or generate), as an MBS session context for the MBS session ID, at least one of MBS service area information for the MBS session ID, mapping information between the MBS session ID and an associated PDU session ID, mapping information between the multicast QoS flow information and the associated QoS flow information, or updated QoS flow information for the PDU session.

The MBS service area information may be a TAI list, a cell ID list, or an NG-RAN node ID list, the QoS flow information may include a QFI and a QoS profile, and the QoS profile may include information indicating a GBR or a non-GBR, a 5QI, an ARP, a GFBR, and an MFBR.

The SMF 540 may store a DL PDR including an SDF template for mapping an SDF of the multicast session to an associated QoS flow.

The SDF template mapped to the associated QoS flow may include multicast IP address information and port information, unicast IP address information and port information, or LL MC address information, for providing multicast data from an MB-UPF 570, which is a user plane anchor for the MBS session, to a UPF 560.

In step 1-5, the SMF 540 may transmit an Nsmf_PDUSession_UpdateSMcontext response message including at least one of the MBS service area information, the MBS session ID, or the mapping information between the MBS session ID and the PDU session ID, as a response to the S-AMF 530.

The SMF 540 may respond to an NG-RAN with at least one of the MBS service area information, the MBS session ID, the mapping information between the MBS session ID and the PDU session ID, the mapping information between the multicast QoS flow information and the associated QoS flow information, or updated QoS flow information for the PDU session in an N2 SM container.

Upon receipt of the Nsmf_PDUSession_UpdateSMcontext response message, the S-AMF 530 may perform a multicast traffic transmission procedure with an NG-RAN node as in step 1-6.

When the UE 500 receives a service from the S-NG-RAN 510 that does not support an MBS function, multicast data may be transmitted to the UE 500 through the associated PDU session in the individual delivery method as in step 2. When the UE 500 performs N2 handover to the T-NG-RAN 520 outside the multicast service area, the S-AMF 530 may transmit a handover command message to the UE 500 through the S-NG-RAN 510 as in step 4 in a handover preparation process in step 3, and the UE 500 may transmit a handover confirm message to the T-NG-RAN 520 as in step 5.

As in step 6, the T-NG-RAN 520 may transmit a handover notify message to the T-AMF 580. Upon receipt of the handover notify message, the T-AMF 580 may notify successful handover of the UE 500 to the T-NG-RAN 520.

In step 7, the T-AMF 580 may notify the S-AMF 530 of the successful handover to the T-NG-RAN 520 by a Namf_Communication_N2InfoNotify message, and the S-AMF 530 may delete a UE context existing in the S-NG-RAN 510 as in step 14.

Upon receipt of the message in step 6, the T-AMF 580 may recognize that the UE 500 has moved out of the multicast service area as in step 8.

In step 9, the T-AMF 580 may transmit an Nsmf_PDUSession_UpdateSMcontext req message (indication=“UE out of service area”, [UE location] included) to the SMF 540 controlling the associated PDU session mapped to the MBS session.

The Nsmf_PDUSession_UpdateSMcontext req message may include an indication indicating that the UE 500 has moved out of the service area or location information about the UE 500 (e.g., a TAI, a cell ID, or an NG-RAN node ID of an NG-RAN to which the UE has moved), further include the MBS session ID, and be transmitted to the SMF 530.

Upon receipt of the Nsmf_PDUSession_UpdateSMcontext req message, the SMF 530 may recognize that the UE 500 has moved out of the service area of the multicast session and control the UE 500 not to receive multicast service data through the associated PDU session mapped to the multicast session as in step 10. The SMF 540 may delete the associated QoS flow of the associated PDU session mapped to the stored multicast QoS flow information for the multicast session, and the SDF template corresponding to the associated QoS flow.

Even though the SMF 530 does not delete the associated QoS flow and the SDF template corresponding to the associated QoS flow, the UPF 560 which has received the multicast data traffic from the MB-UPF 570 may control not to forward multicast data traffic corresponding to the DL PDR including the SDF template for the associated QoS flow of the associated PDU session of the UE 500 to the associated PDU session to the UE 100 or drop the multicast data traffic. For example, the SMF 540 may transmit/receive an N4 Session Modification request/response to/from the UPF 560 so that the SDF corresponding to multicast data traffic from the multicast session may not be forwarded to the associated PDU session of the UE 500 or the multicast data traffic may be dropped, and thus the UE 300 may not receive any more multicast data, as in step 11.

In step 12, the SMF 540 may transmit a Nsmf_PDUSession_UpdateSMcontext response message (including the PDU session ID) to the T-AMF 580, to notify that the handover is confirmed. When the UE 500 has moved to a new registration area, a registration procedure is performed as in step 13.

Since the QoS flow information has been changed in the network, the SMF 540 may perform a PDU session modification procedure to synchronize the QoS flow information between the UE 300 and the network as in step 15.

Steps 15-1 to 15-4 are performed in the same manner as descried before, and thus will not be described herein in detail.

According to an embodiment, step 15 may be performed after step 12, or together with the registration procedure of step 13 without being performed separately. Accordingly, when messages generated in the two processes overlap, they may be integrated into one message and transmitted.

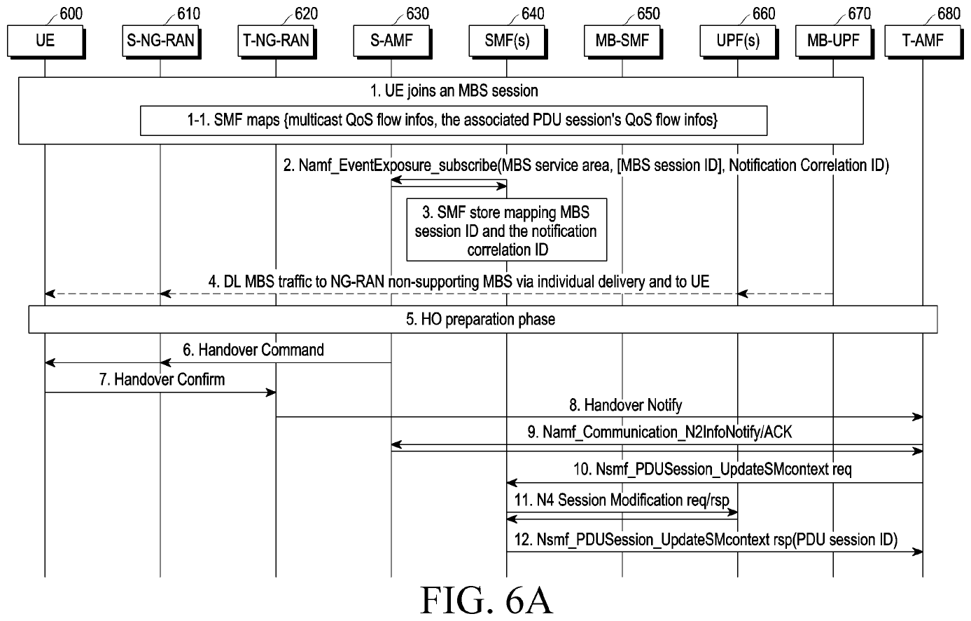

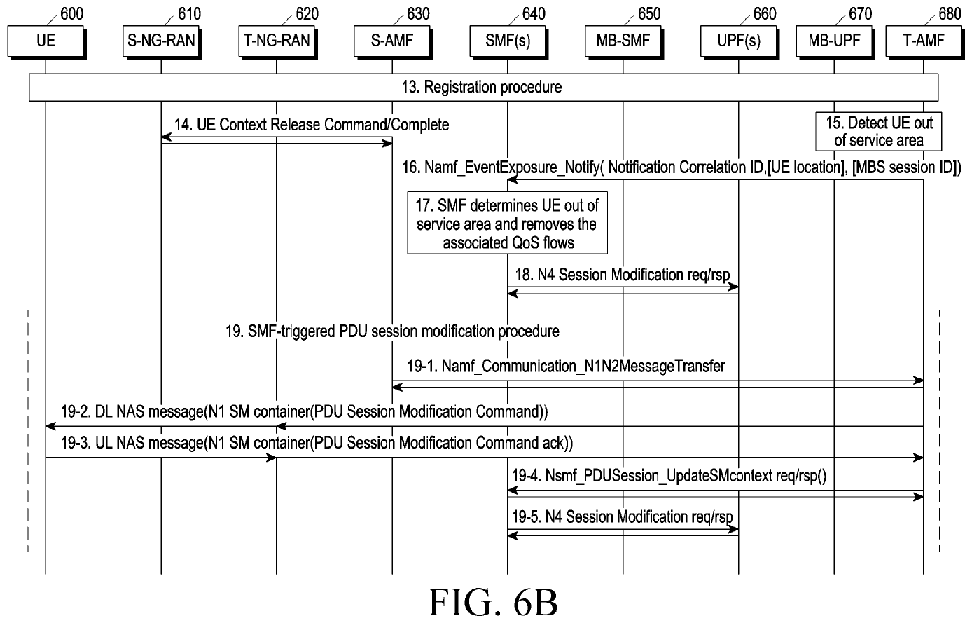

FIGS. 6A and 6B illustrate diagrams of a process of restricting MBS traffic transmission when a UE moves out of an MBS service area through handover according to another embodiment of the disclosure.

When a UE, which has received multicast traffic (or MBS traffic in the individual delivery method, moves out of a service area through N2 handover, a network may recognize the UE being out of the service area and restrict transmission of the multicast traffic to the UE.

Referring to FIGS. 6A and 6B, an SMF 640 may directly perform event subscription to an S-AMF 630 to request a notification in the case of a UE 600 out of an MBS service area.

As in step 1, the UE 600 may request to join a multicast session by a PDU session modification request, to receive a multicast session service. The S-AMF 630 may transmit an Nsmf_PDUSession_UpdateSMcontext request message (including a join request and an MBS session ID) to the SMF 640. In the absence of an MBS session context for the multicast session ID for which the request is made, the SMF 640 receiving the join request may obtain multicast QoS flow information for the multicast session from an MB-SMF 650. Further, the SMF 640 may obtain mapping information between multicast QoS flow information for the multicast session and QoS flow information for an associated PDU session, or may request the QoS flow information for the associated PDU session corresponding the multicast QoS flow information from a PCF and receive the QoS flow information for the associated PDU session. The SMF 640 may obtain the mapping information by autonomously generate the QoS flow information for the associated PDU session based on the multicast QoS flow information.

As in step 1-1, the SMF 640 may store (or generate), as an MBS session context for the MBS session ID, at least one of MBS service area information, the MBS session ID, mapping information between the MBS session ID and an associated PDU session ID, mapping information between the multicast QoS flow information and the associated QoS flow information, or updated QoS flow information for the PDU session.

The MBS service area information may be a TAI list, a cell ID list, or an NG-RAN node ID list, the QoS flow information may include a QFI and a QoS profile, and the QoS profile may include information indicating a GBR or a non-GBR, a 5QI, an ARP, a GFBR, and an MFBR

The SMF 640 may store a DL PDR including an SDF template for mapping an SDF of the multicast session to the associated QoS flow.

The SDF template mapped to the associated QoS flow may include multicast IP address information and port information, unicast IP address information and port information, or LL MC address information, for providing multicast data from an MB-UPF 670, which is a user plane anchor for the MBS session, to a UPF 660.

The SMF 640 may transmit an Nsmf_PDUSession_UpdateSMcontext response message including at least one of the MBS service area information, the MBS session ID, or the mapping information between the MBS session ID and the PDU session ID, as a response to the S-AMF 630.

The SMF 640 may respond to an NG-RAN with at least one of the MBS service area information, the MBS session ID, the mapping information between the MBS session ID and the PDU session ID, the mapping information between the multicast QoS flow information and the associated QoS flow information, or updated QoS flow information for the PDU session in an N2 SM container. Upon receipt of the Nsmf_PDUSession_UpdateSMcontext response message, the S-AMF 630 may perform a multicast traffic transmission procedure with an NG-RAN node.

When the UE 600 is located in a T-NG-RAN 620 that does not support an MBS function after joining, the SMF 640 may transmit multicast data to the UE 600 through the associated PDU session in the individual delivery method.

In step 2, the SMF 640 may subscribe to event notification, requesting a notification in the case of the UE 600 being out of the MBS service area by directly transmitting a Namf_EventExposure_subscribe message (including at least one of the MBS service area information, the MBS session ID, or a notification correlation ID) to the S-AMF 630.

The subscribe message may include the MBS service area information, the MBS session ID, and the notification correlation ID. As in step 3, the SMF 640 subscribed to the event notification may store mapping information between the MBS session ID and the notification correlation ID, to identify an MBS session for which a received notification is. When the UE 600 moves out of the MBS service area, the AMF 430 may notify the SMF 640 of the UE 600 being out of the MBS service area.

As in step 4, when the UE 600 is located in an S-NG-RAN 610 that does not support the MBS function, multicast data may be transmitted to the UE 600 through the associated PDU session in the individual delivery method.

When the UE 600 performs N2 handover to the T-NG-RAN 620 outside the multicast service area, the S-AMF 630 may transmit a handover command message to the UE 600 through the S-NG-RAN 610 as in step 6 in a handover preparation process in step 5, and the UE 600 may transmit a handover confirm message to the T-NG-RAN 620 in step 7.

In step 8, the T-NG-RAN 620 may transmit a handover notify message to the T-AMF 680. Upon receipt of the handover notify message, the T-AMF 680 may notify successful handover of the UE 600 to the T-NG-RAN 620.

In step 9, the T-AMF 680 may notify the successful handover to the T-NG-RAN 620 to the S-AMF 630 by a Namf_Communication_N2InfoNotify message, and the S-AMF 630 may delete a UE context existing in the S-NG-RAN 610 as in step 14.

Upon receipt of the message in step 8, the T-AMF 680 may recognize that the UE 600 has moved out of the multicast service area as in step 15. In step 10, the T-AMF 680 may transmit an Nsmf_PDUSession_UpdateSMcontext req message to the SMF 640 and thus apply the message to the UPF 660 as in step 11. The SMF 640 may notify the T-AMF 680 that the handover is confirmed by transmitting a Nsmf_PDUSession_UpdateSMcontext response message (including the PDU session ID) to the T-AMF 680. When the UE 600 has moved to a new registration area, a registration procedure may be performed as in step 13.

Upon receipt of the handover notify message from the T-NG-RAN 620 in step 8 according to the handover procedure, the T-AMF 680 may recognize that the UE 600 has moved out of the multicast service area as in step 15. Because the SMF 640 has subscribed to the event notification for the case of the UE 600 being out of the multicast service area, the T-AMF 680 may transmit a Namf_EventExposure_Notify message (including the notification correlation ID, the UE location, and the MBS session ID) indicating “the UE out of the MBS service area” to the SMF 640 subscribed to the event notification.

The Namf_EventExposure_Notify message may include event information indicating the UE 600 being out of the service area, the notification correlation ID generated in step 2 during the subscription to the event notification, or location information about the UE 600 (e.g., a TAI, a cell ID, or an NG-RAN node ID of an NG-RAN to which the UE has moved), further include the MBS session ID, and be transmitted to the SMF 640. Upon receipt of the Namf_EventExposure_Notify message, the SMF 640 may recognize that the UE 600 has moved out of the service area of the multicast session, for the MBS session corresponding to the notification correlation ID as in step 17, and control the UE 600 not to receive multicast service data through the associated PDU session mapped to the multicast session.

The SMF 640 may delete the associated QoS flow of the associated PDU session mapped to the stored multicast QoS flow information for the multicast session, and the SDF template corresponding to the associated QoS flow.

Even though the SMF 640 does not delete the associated QoS flow and the SDF template corresponding to the associated QoS flow, the UPF 660 which has received the multicast data traffic from the MB-UPF may control not to forward multicast data traffic corresponding to the DL PDR including the SDF template for the associated QoS flow of the associated PDU session of the UE 600 to the associated PDU session to the UE 400 or to drop the multicast data traffic. For example, the SMF 640 may transmit/receive an N4 Session Modification request/response to/from the UPF 660 so that the SDF corresponding to multicast data traffic from the multicast session may not be forwarded to the associated PDU session of the UE 600 or the multicast data traffic may be dropped, and thus the UE 600 may not receive any more multicast data, as in step 18.

As in step 19, the SMF 640 may perform a PDU session modification procedure to synchronize updated QoS flow information between the UE and the network, and the QoS flow information may be synchronized among the UE 600, the NG-RAN, and the core network.

According to an embodiment, steps 15 to 19 may be performed in parallel with or before the handover procedure, that is, steps 9 to 14. Accordingly, when messages generated in the two procedures overlap, the messages may be integrated into one message and transmitted.

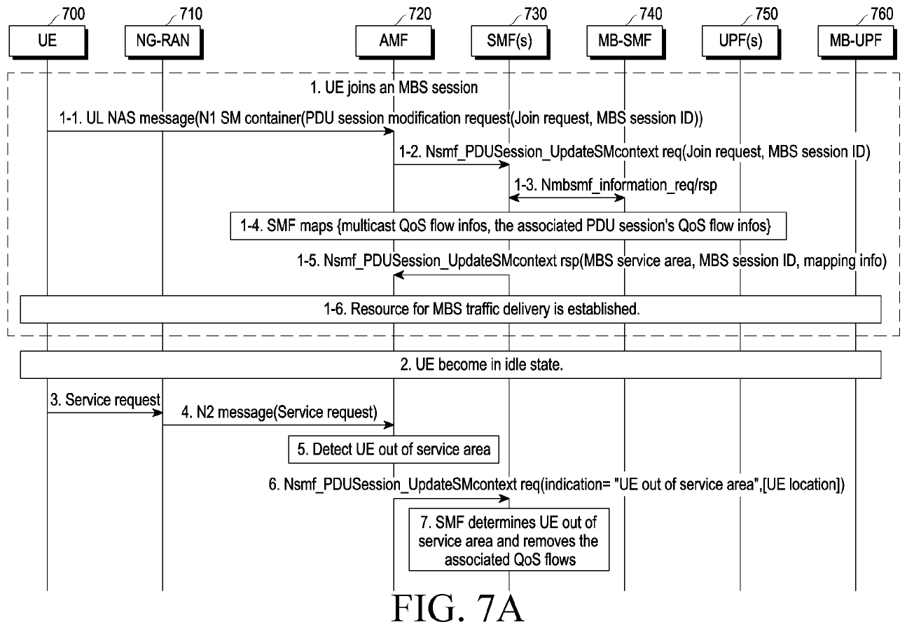

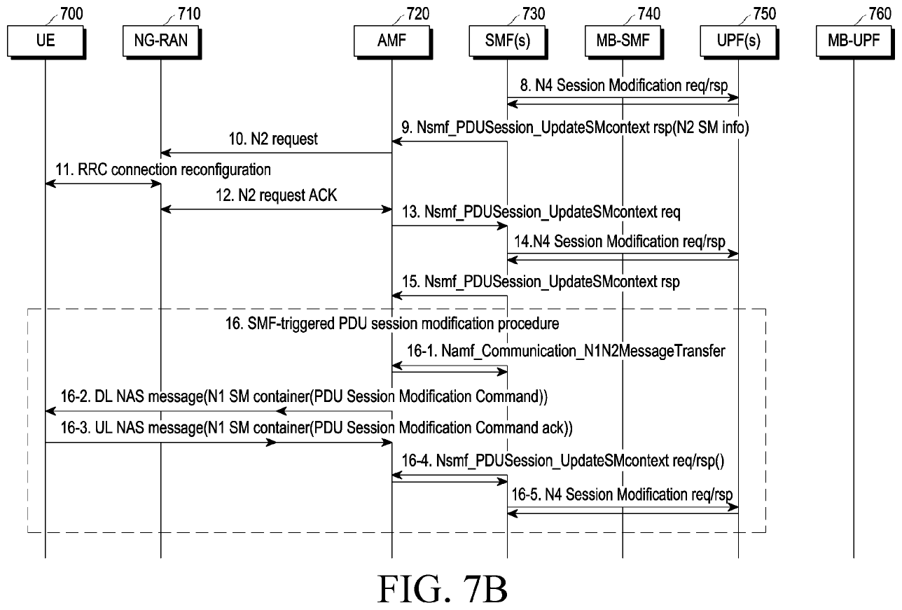

FIGS. 7A and 7B illustrate diagrams of a process of restricting MBS traffic transmission when a UE moves out of an MBS service area in an idle state according to an embodiment of the disclosure.

When the UE moves out of the MBS service area in the idle state and then wakes up, an MBS service may be restricted for the UE.

Referring to FIG. 7A, an SMF 730 may indirectly perform event subscription to an AMF 720 to request a notification in the case of a UE 700 out of an MBS service area in the process of processing a join request for a multicast session from the UE 700 to receive a multicast session service.

In step 1-1, the UE 700 may request to join the multicast session by a PDU session modification request. When the AMF 720 transmits an Nsmf_PDUSession_UpdateSMcontext request message (including a join request and an MBS session ID) to the SMF 730 in step 1-2, in the absence of an MBS session context for the multicast session ID for which the request is made, the SMF 730 receiving the join request may obtain multicast QoS flow information for the multicast session from an MB-SMF 740 in step 1-3.

In step 1-3, the SMF 730 may obtain mapping information between multicast QoS flow information for the multicast session and QoS flow information for an associated PDU session, or may request the QoS flow information for the associated PDU session corresponding the multicast QoS flow information from a PCF and receive the QoS flow information for the associated PDU session.

The SMF 730 may obtain the mapping information by autonomously generating the QoS flow information for the associated PDU session based on the multicast QoS flow information.

The SMF 730 may store (or generate), as an MBS session context for the MBS session ID, at least one of MBS service area information, the MBS session ID, mapping information between the MBS session ID and an associated PDU session ID, mapping information between the multicast QoS flow information and the associated QoS flow information, or updated QoS flow information for the PDU session.

The MBS service area information may be a TAI list, a cell ID list, or an NG-RAN node ID list, the QoS flow information may include a QFI and a QoS profile, and the QoS profile may include information indicating a GBR or a non-GBR, a 5QI, an ARP, a GFBR, and an MFBR.

The SW′ 730 may store a DL PDR including an SDF template for mapping an SDF of the multicast session to the associated QoS flow.

An SDF template mapped to the associated QoS flow may include multicast IP address information and port information, unicast IP address information and port information, or LL MC address information, for providing multicast data from an MB-UPF 760, which is a user plane anchor for the MBS session, to a UPF 750.

In step 1-5, when the SMF 730 transmits an Nsmf_PDUSession_UpdateSMcontext response message to the AMF 720, the SMF 730 may also transmit the MBS service area information, the MBS session ID, and mapping information between the MBS session ID and the PDU session ID. The SMF 340 may respond to an NG-RAN with the MBS service area information, the MBS session ID, the mapping information between the MBS session ID and the PDU session ID, the mapping information between the multicast QoS flow information and the associated QoS flow information, and the updated QoS flow information for the PDU session in an N2 SM container. Upon receipt of the Nsmf_PDUSession_UpdateSMcontext response message, the AMF 720 may perform a multicast traffic transmission procedure with an NG-RAN node as in step 1-6.

A situation in which the UE 700 is later switched to the idle state as in step 2 is considered. When the UE 700 moves and is to be switched to a connected state, the UE 700 may transmit a service request message to the AMF 720 through an NG-RAN 710 as in steps 3 and 4. The NG-RAN 710 may transmit location information about the UE 700 by an N2 message to the AMF 720 in step 4, and the AMF 720 may recognize that the UE 700 has moved out of the service area as in step 5.

In step 6, the AMF 720 may transmit an Nsmf_PDUSession_UpdateSMcontext req message (indication=“UE out of service area”, [UE location] included) to the SMF 730 controlling the associated PDU session mapped to the MBS session.

The Nsmf_PDUSession_UpdateSMcontext req message may include an indication indicating that the UE 700 has moved out of the service area or location information about the UE 700 (e.g., a TAI, an ID, or an NG-RAN node ID of an NG-RAN to which the UE has moved), further include the MBS session ID, and be transmitted to the SMF 730.

Upon receipt of the Nsmf_PDUSession_UpdateSMcontext req message, the SMF 730 may recognize that the UE 700 has moved out of the service area of the multicast session, and control the UE 700 not to receive multicast service data through the associated PDU session mapped to the multicast session as in step 7.

The SMF 730 may delete the associated QoS flow of the associated PDU session mapped to the stored multicast QoS flow information for the multicast session, and the SDF template corresponding to the associated QoS flow.

Even though the SMF 730 does not delete the associated QoS flow and the SDF template corresponding to the associated QoS flow, the UPF 750 which has received multicast data traffic from the MB-UPF 760 may control not to forward multicast data traffic corresponding to the DL PDR including the SDF template for the associated QoS flow of the associated PDU session of the UE 700 to the associated PDU session to the UE 700 or to drop the multicast data traffic. For example, the SMF 730 may transmit/receive an N4 Session Modification request/response to/from the UPF 750 so that the SDF corresponding to multicast data traffic from the multicast session may not be forwarded to the associated PDU session of the UE 700 or the multicast data traffic may be dropped, and thus the UE 700 may not receive any more multicast data, as in step 8.

The SMF 730 may transmit a Nsmf_PDUSession_UpdateSMcontext response message (including N2 SM info) to the AMF 720 in step 9, the AMF 720 may transmit an N2 request to the NG-RAN 710, and the NG-RAN 710 may perform a service request-based procedure with the UE 700, such as allocation of resources by signaling.

Since QoS flow information has been changed in the network, the SMF 730 may perform a PDU session modification procedure to synchronize the QoS flow information between the UE 700 and the network as in step 16.

According to an embodiment, step 16 may be performed after step 8 or in parallel with steps 9 to 15. Accordingly, when messages generated in the two procedures overlap, the messages may be integrated into one message and transmitted.

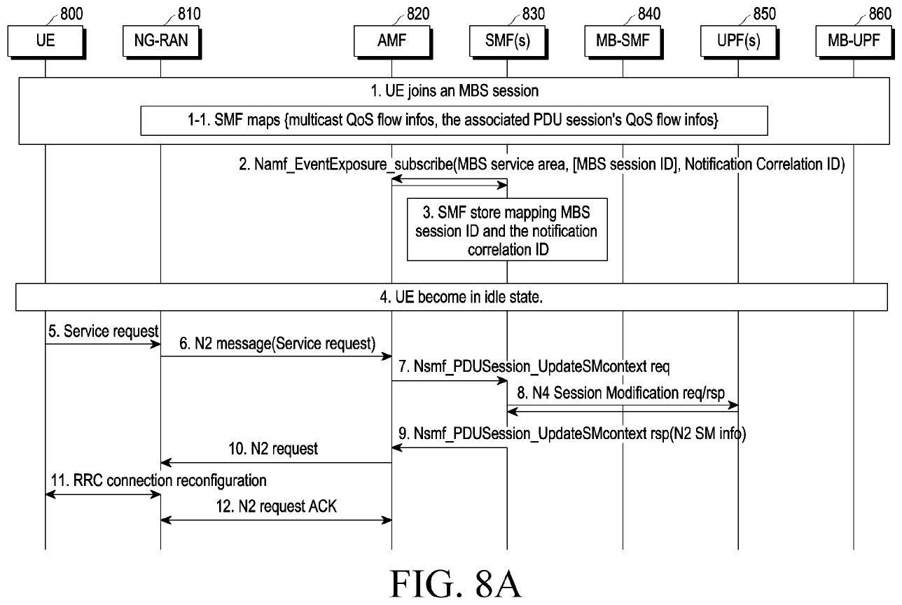

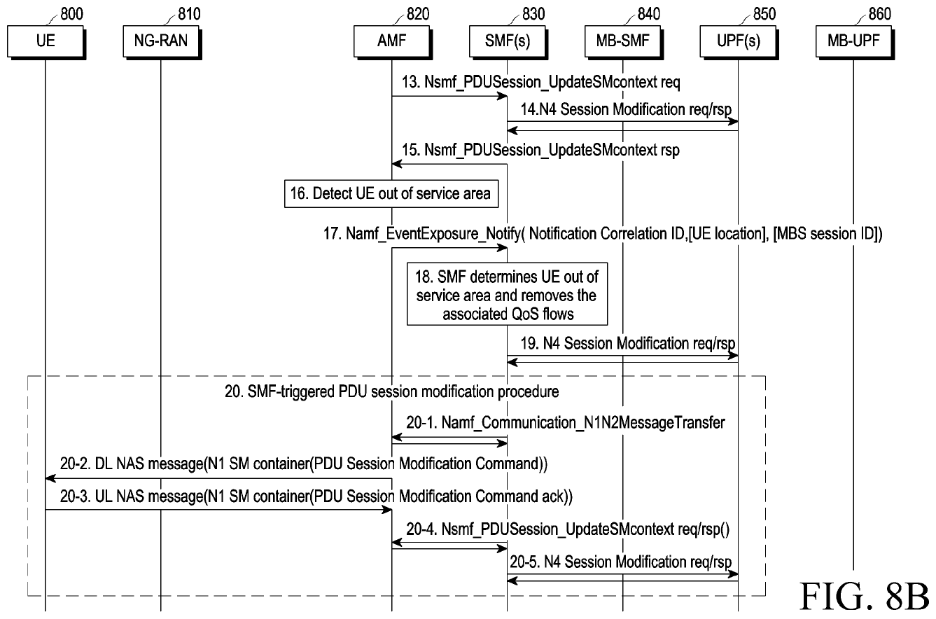

FIGS. 8A and 8B illustrate diagrams of a process of restricting MBS traffic transmission when a UE moves out of an MBS service area in an idle state according to another embodiment of the disclosure.

According to an embodiment, when a UE 800 moves out of the MBS service area in the idle state and then wakes up, a process of restricting a multicast service may be required.

Referring to FIG. 8A, the UE 800 may request to join a multicast session by a PDU session modification request, to receive a multicast session service. When an AMF 820 transmits an Nsmf_PDUSession_UpdateSMcontext request message (including a join request and an MBS session ID) to an SMF 830, in the absence of an MBS session context for the multicast session ID for which the request is made, the SMF 830 receiving the join request may obtain multicast QoS flow information for the multicast session from an MB-SMF 840.

The SMF 830 may obtain mapping information between the multicast QoS flow information for the multicast session and QoS flow information for an associated PDU session, or may request the QoS flow information for the associated PDU session corresponding the multicast QoS flow information from a PCF and receive the QoS flow information for the associated PDU session.

The SMF 830 may obtain the mapping information by autonomously generate the QoS flow information for the associated PDU session based on the multicast QoS flow information.

In step 1-1, the SMF 830 may store (or generate), as an MBS session context for the MBS session ID, at least one of MBS service area information, the MBS session ID, mapping information between the MBS session ID and an associated PDU session ID, mapping information between the multicast QoS flow information and the associated QoS flow information, or updated QoS flow information for the PDU session.

The MBS service area information may be a TAI list, a cell ID list, or an NG-RAN node ID list, the QoS flow information may include a QFI and a QoS profile, and the QoS profile may include information indicating a GBR or a non-GBR, a 5QI, an ARP, a GFBR, and an MFBR.

The SMF 830 may store a DL PDR including an SDF template for mapping an SDF of the multicast session to the associated QoS flow.

The SDF template mapped to the associated QoS flow may include multicast IP address information and port information, unicast IP address information and port information, or LL MC address information, for providing multicast data from an MB-UPF 860, which is a user plane anchor for the MBS session, to a UPF 850.

When the SMF 830 transmits a response to the AMF 820 by an Nsmf_PDUSession_UpdateSMcontext response message, the SMF 340 may also transmit the MBS service area information, the MBS session ID, and the mapping information between the MBS session ID and the PDU session ID.

The SMF 830 may transmit the MBS service area information, the MBS session ID, the mapping information between the MBS session ID and the PDU session ID, the mapping information between the multicast QoS flow information and the associated QoS flow information, and the updated QoS flow information for the PDU session in an N2 SM container, as a response to an NG-RAN 810.

Upon receipt of the Nsmf_PDUSession_UpdateSMcontext response message, the AMF 820 may perform a multicast traffic transmission procedure with an NG-RAN node.

When the UE 800 is located in the NG-RAN 810 that does not support an MBS function after joining, the SMF 830 may transmit multicast data to the UE 800 in the individual delivery method.

A situation in which the UE 800 is switched to the idle state as in step 4 is considered. When the UE 800 moves and is to be switched to the connected state, the UE 800 may transmit a service request message to the AMF 820 through the NG-RAN 810 as in steps 5 and 6. The NG-RAN 810 may transmit location information about the UE 800 by an N2 message to the AMF 820 in step 6, and the AMF 820 may recognize that the UE 800 has moved out of the service area as in step 16.

As in step 7, the AMF 820 may transmit an Nsmf_PDUSession_UpdateSMcontext req message to the SMF 830. Upon receipt of the Nsmf_PDUSession_UpdateSMcontext req message, the SMF 830 may apply the contents of the message to the UPF 850 as in step 8. The SMF 830 may transmit a Nsmf_PDUSession_UpdateSMcontext response message (including N2 SM info) to the AMF 820 in step 9. The AMF 820 may transmit an N2 request message to the NG-RAN 810 in step 10, and thus the NG-RAN 810 may perform a service request-based procedure with the UE 800, such as allocation of resources by signaling as in step 11.

Upon receipt of an N2 message from the NG-RAN 810 in step 6, the AMF 820 may recognize that the UE 800 has moved out of the multicast service areas as in step 16.

Because the SMF 840 has subscribed to the event notification for the case of the UE 800 being out of the multicast service area, the AMF 820 may transmit a Namf_EventExposure_Notify message (including the notification correlation ID, the UE location, and the MBS session ID) indicating “the UE out of the MBS service area” to the SMF 830 subscribed to the event notification.

The Namf_EventExposure_Notify message may include event information indicating the UE being out of the service area, the notification correlation ID generated in step 2 during the subscription to the event notification, or location information about the UE 800 (e.g., a TAI, a cell ID, or an NG-RAN node ID of an NG-RAN to which the UE has moved), further include the MBS session ID, and be transmitted to the SMF 830.

As in step 18, upon receipt of the Namf_EventExposure_Notify message, the SMF 830 may recognize that the UE 800 has moved out of the service area of the multicast session, for the MBS session corresponding to the notification correlation ID, and control the UE 800 not to receive multicast service data through the associated PDU session mapped to the multicast session.

The SMF 830 may delete the associated QoS flow of the associated PDU session mapped to the stored multicast QoS flow information for the multicast session, and the SDF template corresponding to the associated QoS flow.

Even though the SMF 830 does not delete the associated QoS flow and the SDF template corresponding to the associated QoS flow, the UPF 850 which has received multicast data traffic from the MB-UPF 860 may control not to forward multicast data traffic corresponding to the DL PDR including the SDF template for the associated QoS flow of the associated PDU session of the UE 800 to the associated PDU session to the UE 800 or to drop the multicast data traffic. For example, the SMF 830 may transmit/receive an N4 Session Modification request/response to/from the UPF 850 so that the SDF corresponding to multicast data traffic from the multicast session may not be forwarded to the associated PDU session of the UE 800 or may be dropped, and thus the UE 800 may not receive any more multicast data, as in step 19.

As in step 20, the SMF 830 may perform a PDU session modification procedure to synchronize the updated QoS flow information between the UE 800 and the network, and the QoS flow information may be synchronized among the UE 800, the NG-RAN 810, and the core network.

According to an embodiment, steps 16 to 20 may be performed in parallel with or before the handover procedure, that is, steps 8 to 15. Accordingly, when messages generated in the two procedures overlap, the messages may be integrated into one message and transmitted.

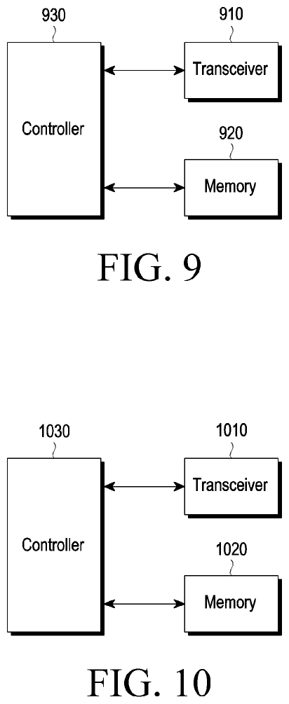

FIG. 9 illustrates the structure of an SMF according to an embodiment of the disclosure.

An SMF described with reference to FIGS. 1 to 8 may correspond to the SMF of FIG. 9.

Referring to FIG. 9, the SMF may include a transceiver 910, a memory 920, and a controller 930. The SMF transceiver 910, the controller 930, and the memory 920 may operate according to the SMF communication methods described above. However, the components of the SMF are not limited to the above example. For example, the SMF may include more or fewer components than the above components. In addition, the transceiver 910, the controller 930, and the memory 920 may be implemented in the form of a single chip. Further, the controller 930 may include one or more processors.

The transceiver 910 collectively refers to a receiver of the SMF and a transmitter of the SMF, and may transmit and receive signals to and from other network entities. To this end, the transceiver 910 may include a radio frequency (RF) transmitter that up-converts the frequency of a transmitted signal and amplifies the up-converted signal, and an RF receiver that low-noise amplifies a received signal and down-converts the low-noise-amplified signal. However, this is only an embodiment of the transceiver 910, and the components of the transceiver 910 are not limited to the RF transmitter and the RF receiver.

In addition, the transceiver 910 may receive a signal on a radio channel, output the received signal to the controller 930, and transmit a signal received from the controller 930 on a radio channel.

The memory 920 may store a program and data required for the operations of the SMF. Further, the memory 920 may store control information or data included in a signal obtained at the SMF. The memory 920 may be configured as a storage medium such as read only memory (ROM), random access memory (RAM), a hard disk, a compact disk ROM (CD-ROM), a digital versatile disk (DVD), or a combination of these storage media. The memory 920 may be included in the processor 930, not existing separately.

The controller 930 may control a series of processes so that the SMF operates according to the above-described embodiments of the disclosure. For example, the controller 930 may receive a control signal and a data signal through the transceiver 910 and process the received control signal and data signal. Further, the controller 930 may transmit a processed control signal and data signal through the transceiver 910. There may be a plurality of controllers 930, and the controller 930 may execute a program stored in the memory 420 to perform a control operation for the components of the SMF.

The controller 930 may control to transmit a first message including information about an MBS area and an MBS session ID to an AMF, control to receive a second message indicating that a UE receiving a service within the MBS area is located outside the MBS area from the AMF, determine that the UE is located outside the MBS area based on the second message, and process a QoS flow applied to MBS traffic delivered by individual delivery.

The controller 930 may delete the QoS flow or drop data traffic applied to a PDR (SDF template) for the QoS flow.

The controller 930 may control to receive a third message including a session join request of the UE and the MBS session ID from the AMF. The first message may be transmitted to the AMF in response to the third message.

According to an embodiment, the first message may be a subscribe message for receiving an event notification when the UE located in the MBS area moves out of the MBS area.

The controller 930 may store mapping information between the MBS session ID and a notification correlation ID, and identify that the second message is an event notification for the MBS session ID based on the mapping information.

FIG. 10 illustrates the structure of an AMF according to an embodiment of the disclosure.

The AMF described with reference to FIGS. 1 to 8 may correspond to the AMF of FIG. 10.

Referring to FIG. 10, the SMF may include a transceiver 1010, a memory 1020, and a controller 1030. The SMF transceiver 1010, the controller 1030, and the memory 1020 may operate according to the SMF communication method described above. However, the components of the SMF are not limited to the above-described example. For example, the SMF may include more or fewer components than the above components. In addition, the transceiver 1010, the controller 1030, and the memory 1020 may be implemented in the form of a single chip. Further, the controller 1030 may include one or more processors.

The transceiver 1010 collectively refers to a receiver of the SMF and a transmitter of the UE, and may transmit and receive signals to and from other network entities. To this end, the transceiver 1010 may include an RF transmitter that up-converts the frequency of a transmitted signal and amplifies the up-converted signal, and an RF receiver that low-noise amplifies a received signal and down-converts the low-noise-amplified signal. However, this is only an embodiment of the transceiver 1010, and the components of the transceiver 1010 are not limited to the RF transmitter and the RF receiver.

In addition, the transceiver 1010 may receive a signal on a radio channel, output the received signal to the controller 1030, and transmit a signal received from the controller 1030 on a radio channel.

The memory 1020 may store a program and data required for the operations of the SMF. Further, the memory 1020 may store control information or data included in a signal obtained at the AMF. The memory 1020 may be configured as a storage medium such as ROM, RAM, a hard disk, a CD-ROM, a DVD, or a combination of these storage media. The memory 1020 may be included in the controller 1030, not existing separately.

The controller 1030 may control a series of processes so that the AMF operates according to the above-described embodiments of the disclosure. For example, the controller 1030 may receive a control signal and a data signal through the transceiver 1030 and process the received control signal and data signal. Further, the controller 1030 may transmit a processed control signal and data signal through the transceiver 1010. There may be a plurality of controllers 1030, and the controller 1030 may execute a program stored in the memory 1020 to perform a control operation for the components of the AMF.

The controller 1030 may control to receive a first message including information about an MBS area and an MBS session ID from an SMF, and control to transmit a second message indicating that a UE receiving a service within the MBS area is located outside the MBS area to the SMF. A QoS flow applied to MBS traffic delivered by individual delivery may be processed based on the second message.

Methods according to the embodiments described in the claims or specifications of the disclosure may be implemented in the form of hardware, software, or a combination of hardware and software.

When the methods are implemented in software, a computer-readable storage medium storing at least one program (software module) may be provided. The at least one program stored in the computer-readable storage medium are configured for execution by at least one processor in an electronic device. The at least one program includes instructions that cause the electronic device to execute the methods according to the embodiments described in the claims or specification of the disclosure.

The program (software module or software) may be stored in RAM, non-volatile memory including flash memory, ROM, electrically erasable programmable ROM (EEPROM), a magnetic disk storage device, a CD-ROM, a DVD, other types of optical storage devices, or a magnetic cassette. Alternatively, the program may be stored in a memory configured as a combination of some or all of them. In addition, a plurality of constituent memories may be included.

In addition, the program may be stored on an attachable storage device accessible through a communication network including a communication network such as the Internet, an intranet, a local area network (LAN), a wide area network (WAN), a storage area network (SAN), or a combination thereof. The storage device may be connected to a device implementing an embodiment of the disclosure through an external port. Additionally, a separate storage device on the communication network may be connected to the device implementing the embodiment of the disclosure.

In the specific embodiments of the disclosure described above, components included in the disclosure are expressed in a singular or plural form according to the specific embodiments. However, the singular or plural expression is appropriately selected for a presented context, for convenience of description, and the disclosure is not limited to a single component or a plurality of components. Even a component expressed as a plural form may be provided as a single one, or even a component expressed as a singular form may be provided in plurality. It should also be noted that functions recited in blocks may occur out of order in some alternative implementations. For example, two blocks shown as one after another may be executed substantially simultaneously or in a reverse order according to a corresponding function.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of controlling multicast and broadcast service (MBS) by a session management function (SMF) in a wireless communication system, the method comprising:
obtaining information on an MBS service area of an MBS session;
subscribing to a user equipment (UE) mobility event notification from a mobility management function (AMF), wherein the UE mobility event notification indicates that the UE moving into or out of the MBS service area;
receiving, from the AMF, user location information for the UE; and
determining whether the UE is outside the MBS service area based on the user location information for the UE.

2. The method of claim 1, further comprising:
in response to the UE being out of the MBS service area, deleting an associated QoS flow for the MBS session.

3. The method of claim 1, wherein the MBS service area is cell ID list or tracking area ID (TAI) list.

4. The method of claim 1, further comprising:
transmitting, to the AMF, a Namf_EventExposure_subscribe message to subscribe to the UE mobility event notification from the AMF.

5. The method of claim 1, wherein the user location information for the UE includes cell ID for a target NG-RAN to which the UE moved or tracking area ID (TAI) for the target NG-RAN.

6. The method of claim 1, wherein the UE moves from the MBS service area to the outside of the MBS service area through N2 handover.

7. A method of controlling multicast and broadcast service (MBS) by an access and mobility management function (AMF) in a wireless communication system, the method comprising:
receiving, from a session management function (SMF), a message to subscribe to a user equipment (UE) mobility event notification, wherein the UE mobility event notification indicates that the UE moving into or out of an MBS service area of an MBS session; and
transmitting, to the SMF, user location information for the UE,
wherein the user location information for the UE is used to determine whether the UE is outside the MBS service area.

8. The method of claim 7, wherein an associated QoS flow for the MBS session is deleted in response to the UE being out of the MBS service area.

9. The method of claim 7, wherein the MBS service area is cell ID list or tracking area ID (TAI) list.

10. The method of claim 7, wherein the user location information for the UE includes cell ID for a target NG-RAN to which the UE moved or tracking area ID (TAI) for the target NG-RAN.

11. A session management function (SMF) for controlling multicast and broadcast service (MBS) in a wireless communication system, the SMF comprising:
a transceiver; and
a controller coupled with the transceiver and configured to control to:
obtain information on an MBS service area of an MBS session,
subscribe to a user equipment (UE) mobility event notification from a mobility management function (AMF), wherein the UE mobility event notification indicates that the UE moving into or out of the MBS service area,
receive, from the AMF, user location information for the UE, and
determine whether the UE is outside the MBS service area based on the user location information for the UE.

12. The SMF of claim 11, wherein the controller is configured to delete an associated QoS flow for the MBS session in response to the UE being out of the MBS service area.

13. The SMF of claim 11, wherein the MBS service area is cell ID list or tracking area ID (TAI) list.

14. The SMF of claim 11, wherein the controller is configured to transmit, to the AMF, a Namf_EventExposure_subscribe message to subscribe to the UE mobility event notification from the AMF.

15. The SMF of claim 11, wherein the UE moves from the MBS service area to the outside of the MBS service area through N2 handover.

16. The SMF of claim 11, wherein the user location information for the UE includes cell ID for a target NG-RAN to which the UE moved or tracking area ID (TAI) for the target NG-RAN.

17. An access and mobility management function (AMF) for controlling multicast and broadcast service (MBS) in a wireless communication system, the AMF comprising:
a transceiver; and
a controller coupled with the transceiver and configured to control to:
receive, from a session management function (SMF), a message to subscribe to a user equipment (UE) mobility event notification, wherein the UE mobility event notification indicates that the UE moving into or out of an MBS service area of an MBS session, and
transmit, to the SMF, user location information for the UE,
wherein the user location information for the UE is used to determine whether the UE is outside the MBS service area.

18. The AMF of claim 17, wherein an associated QoS flow for the MBS session is deleted in response to the UE being out of the MBS service area.

19. The AMF of claim 17, wherein the MBS service area is cell ID list or tracking area ID (TAI) list.

20. The AMF of claim 17, wherein the user location information for the UE includes cell ID for a target NG-RAN to which the UE moved or tracking area ID (TAI) for the target NG-RAN.
